(19) United States
(12) Patent Application Publication
(10) Pub. No.: US 2010/0081837 A1
(43) Pub. Date: Apr. 1, 2010

(54) PROCESS FOR PRODUCTION OF POWDER OF CAGE SILSESQUIOXANE COMPOUND

(75) Inventor: Hideo Saito, Tokyo (JP)

Correspondence Address: GREENBLUM & BERNSTEIN, P.L.C., 1950 ROLAND CLARKE PLACE, RESTON, VA, 20191, US

(73) Assignee: ASAHI KASEI CHEMICALS CORPORATION, Tokyo (JP)

(21) Appl. No.: 12/444,285

(22) PCT Filed: Oct. 5, 2007
(86) PCT No.: PCT/JP2007/069624

§ 371 Date: Apr. 3, 2009

(30) Foreign Application Priority Data
Oct. 5, 2006 (JP) 2006-273781

(51) Int. Cl. C07F 7/10; C07F 7/02

(52) U.S. Cl. 556/413; 556/443

(57) ABSTRACT

An object of the present invention is to provide a process for producing a powder of a cage silsesquioxane compound by simple operations. In the invention, a high-quality powder of a cage silsesquioxane compound is obtained by reacting a partially cleaved structure of a cage silsesquioxane having a specific structure with an alkoxysilane to obtain a solution containing the cage silsesquioxane compound and further by treating the solution in a thin-film distillation machine.

### TECHNICAL FIELD

The present invention relates to a process for drying and powdering a cage silsesquioxane compound. More specifically, it relates to a technology for producing a powder of a cage silsesquioxane compound, which is industrially useful, by simple operations through simultaneous solvent evaporation and powdering from a solution containing the cage silsesquioxane compound by reacting a partially cleaved structure of the cage silsesquioxane having a specific structure with an alkoxysilane. Namely, according to the invention, by simple operations, it becomes possible to obtain a fine-particle powder of a cage silsesquioxane compound, which contains little residual solvents and is industrially easily utilized.

### BACKGROUND ART

A cage silsesquioxane compound is extremely useful as an additive for modifying thermoplastic resins. Particularly, in a resin composition composed of a polyphenylene ether-based resin or a polycarbonate-based resin and a cage silsesquioxane, an improvement in melt moldability and an improvement in flame resistance by a non-halogen and non-phosphorus additive can be realized at the same time.

As a method for adding the cage silsesquioxane compound at the time when these resin compositions are kneaded by melt extrusion, a method of pre-mixing a thermoplastic resin and the cage silsesquioxane compound and a method of adding the cage silsesquioxane compound from a side-feed on the way of extrusion may be mentioned.

As the method for adding the cage silsesquioxane compound to a thermoplastic resin, the method by pre-mixing is desirable. However, most of the cage silsesquioxane compounds are waxy or tend to agglomerate. Thus, at the pre-mixing with a thermoplastic resin, when a lumpish cage silsesquioxane compound or a cage silsesquioxane compound having a large particle size is used as it is, the dispersion of the cage silsesquioxane compound into extruded and kneaded pellets becomes heterogeneous in some cases. Therefore, in order to achieve homogeneous dispersion, the cage silsesquioxane compound should be processed through pulverization or the like so as to have a particle size within a certain range.

As a process for producing the cage silsesquioxane compound, there has been reported a process for producing it by capping a trisilanol compound which is a partially cleaved structure of the cage silsesquioxane compound and, for example, an objective compound is obtained by adding pyridine to a mixture of the trisilanol compound and a trichlorosilane represented by RSiCl₃ in a nitrobenzene solution to react them and precipitating crystals (Non-Patent Document 1).

Furthermore, as a method for introducing a functional group into the cage silsesquioxane, there has been reported an equimolar reaction wherein a partially cleaved structure of the cage silsesquioxane compound, a chlorosilane-based compound, and triethylamine as a reaction-inducing agent are used (Patent Documents 1 and 2).

However, since a large amount of triethylammonium chloride as a salt is formed as a by-product in the above method, vexatious operations and a great deal of energy are required for separation of the by-product and purification of the objective product.

As other processes, processes for capping trisilanol compounds with alkoxysilanes have been reported. However, there is a problem that the yields are low since the purification step is conducted by re-precipitation with a poor solvent such as acetonitrile in all the processes (Patent Documents 3 to 5).

On the other hand, the present inventors have previously invented a process for capping a terminal silanol group of a partially cleaved structure of a cage silsesquioxane compound with an alkoxysilane. Specifically, they have invented a process for capping by bringing the partially cleaved structure of the cage silsesquioxane compound into contact with the alkoxysilane in the case of using an alkoxysilane containing an amino group, and a process for capping using a Lewis base as a catalyst in the case of using an alkoxysilane containing no amino group (Patent Documents 6 and 7).

In the above processes, since the catalyst can be also removed by distillation at the time when the solvent was removed by a method of distillation or the like, a highly pure cage silsesquioxane compound can be obtained by simple operations.

However, in any of the processes, when the solvent is removed by a method of distillation or the like at the production of the cage silsesquioxane compound, the cage silsesquioxane compound tends to be agglomerated in many cases. Also, there is a problem that some of the produced cage silsesquioxane compounds tend to be decomposed when they are dried in an agglomerated state under a heated condition for a long period of time. Therefore, after the solvent is removed by distillation or the like to some degree, it is necessary to dry the compound after the agglomerated compound is powdered through a step of pulverization or the like. Thus, it has been desired to dry and powder the compound easily at the same time.

Non-Patent Document 1: Brown & Vogt, J. Amer. Chem. Soc., (1965), 4313
Patent Document 1: U.S. Pat. No. 5,484,867
Patent Document 2: WO01/010871 pamphlet
Patent Document 3: WO03/064490 pamphlet
Patent Document 4: WO03/042223 pamphlet
Patent Document 5: WO04/063207 pamphlet

### Patent Document 6: JP-A-2004-51847

### Patent Document 7: JP-A-2004-51848

### DISCLOSURE OF THE INVENTION

### Problems that the Invention is to Solve

In consideration of such current situations, an object of the invention is to provide a process for producing various cage silsesquioxane compounds, which are useful as polymer additives, as powders containing little residual solvents and easy to handle in high yields by simple operations.

### Means for Solving the Problems

As a result of extensive studies for achieving the above object, the present inventors have found a process for producing a powder of a high-quality cage silsesquioxane compound in a simple manner and in high yields by thin-layer distillation from a solution of a cage silsesquioxane compound having a specific structure and thus they have accomplished the invention.

Namely, the invention relates to the following:

(1) A process for producing a powder of a cage silsesquioxane compound, the process comprising: reacting a trisilanol compound represented by the general formula (A) with an alkoxysilane represented by the general formula (B) in an organic solvent in the presence of a Lewis base to obtain a solution containing the cage silsesquioxane compound; and subsequently performing a solvent evaporation and powdering of the solution by means of a thin-film distillation machine, simultaneously:

(RSiO_{3/2})ₙ(RSiO₂H)₃ (A)

R¹ₘSi(OR²)₄₋ₘ (B)

wherein, in the general formula (A), R is selected from a hydrogen atom, a substituted or unsubstituted hydrocarbon group having 1 to 10 carbon atoms, and a silicon atom-containing group having 1 to 3 silicon atoms, and a plurality of R's may be the same or different; and n is an integer of 2 to 10; in the general formula (B), R¹ is a group selected from the group the same as that for the above R, and a plurality of R¹'s may be the same or different; OR² is an alkoxyl group having 1 to 6 carbon atoms; and m is an integer of 1 to 3.

(2) The process for producing the powder of the cage silsesquioxane compound according to (1), wherein R¹ in the alkoxysilane represented by the general formula (B) has an amino group as a substituent.

(3) The process for producing the powder of the cage silsesquioxane compound according to (1), wherein the Lewis base is an alkoxysilane containing the amino group.

(4) The process for producing the powder of the cage silsesquioxane compound according to (1), wherein the Lewis base is an amine compound having 1 to 20 carbon atoms.

(5) The process for producing the powder of the cage silsesquioxane compound according to (1), wherein the cage silsesquioxane compound is represented by any structure of the following formulae (C) to (E):

(RSiO_{3/2})ₙ₊₃(R¹SiO_{3/2}) (C)

(RSiO_{3/2})ₙ₊ₕ(RSiO₂H)₃₋ₕ(R¹ₘSiO_{(4-m)/2})ᵢ (D)

(RSiO_{3/2})ₙ₊₃(R¹₂SiO)(R¹₂SiO_{3/2}H) (E)

wherein n, R and R¹ are the same as described in the above (1); m=2 or 3; and in the case where m=2, i=1 and h=2; and in the case where m=3, i=h=an integer of 1 to 3.

(6) The process for producing the powder of the cage silsesquioxane compound according to any of (1) to (5), wherein the trisilanol compound represented by the general formula (A) is:

(RSiO_{3/2})₄(RSiO₂H)₃,

the alkoxysilane represented by the general formula (B) is:

R¹Si(OR²)₃,

and the cage silsesquioxane compound obtained by reacting the trisilanol compound with the alkoxysilane is:

(RSiO_{3/2})₇(R¹SiO_{3/2})

wherein R and R¹ are the same as described in the above (1).

(7) The process for producing the powder of the cage silsesquioxane compound according to any of (1) to (6), wherein the solvent of the solution containing the cage silsesquioxane compound is a mixed solvent of at least one solvent selected from hydrocarbon-based solvents, ethereal solvents and polar solvents and an alcoholic solvent having 1 to 8 carbon atoms and the mixed solvent contains 1 wt % to 95 wt % of the alcoholic solvent based on 100 wt % of the mixed solvent.

(8) The process for producing the powder of the cage silsesquioxane compound according to any of (1) to (7), wherein a viscosity of the solution containing the cage silsesquioxane compound at the time when it is treated in the thin-film distillation machine is 0.1 cp to 1000 cp.

(9) The process for producing the powder of the cage silsesquioxane compound according to any of (1) to (8), wherein a temperature of an inner wall of the thin-film distillation machine is a temperature which is 10° C. or more lower than either lower temperature of a melting point or a softening start temperature of the cage silsesquioxane compound.

(10) The process for producing the powder of the cage silsesquioxane compound according to any of (1) to (9), wherein either lower temperature of the melting point or the softening start temperature of the cage silsesquioxane compound is 50° C. or higher.

(11) The process for producing the powder of the cage silsesquioxane compound according to any of (1) to (10), wherein a residual amount of the solvent contained in the powder of the cage silsesquioxane compound is 3 wt % or less.

(12) The process for producing the powder of the cage silsesquioxane compound according to any of claims (1) to (10), wherein the trisilanol compound represented by the general formula (A) is subjected to a treatment of removing alkali metal compounds shown by the following steps:

(a) a composition containing the trisilanol compound is brought into contact with a hydrophobic organic solvent having a water solubility at 20° C. of 1.0% by weight or less to obtain an organic phase wherein the trisilanol compound represented by the general formula (A) is dissolved in the hydrophobic organic solvent, and

(b) a fine-particle dispersoid is removed from the hydrophobic organic solvent phase.

(13) The process for producing the powder of the cage silsesquioxane compound according to (12), wherein the step of removing the fine-particle dispersoid is a step of a filtration treatment through a hydrophobic filter having an average pore size of 0.005 μm to 100 μm.

### ADVANTAGE OF THE INVENTION

According to the production process of the invention, it becomes possible to obtain a fine-particle powder of a cage silsesquioxane compound, which contains little residual solvents and is industrially easily utilizable, by simple operations.

### BEST MODE FOR CARRYING OUT THE INVENTION

The following will explain the present invention in detail.

While silica is represented by SiO₂, a silsesquioxane compound is a compound represented by [R′SiO_{3/2}]. The silsesquioxane is a polysiloxane usually synthesized by hydrolysis-polycondensation of an R′SiX₃ (R′=a hydrogen atom, an organic group, or a siloxy group, X=a halogen atom or an alkoxy group) type compound. As shapes of molecular arrangement, there are known typically an amorphous structure, a ladder structure, a cage (completely condensed cage) structure or a partially cleaved structure thereof (a structure wherein one silicon atom is removed from the cage structure or a structure wherein a part of silicon-oxygen bonds is cleaved), or the like.

The cage silsesquioxane compound produced in the invention is a silsesquioxane compound having a cage structure. Specifically, it has a cage (completely condensed cage) structure or a partially cleaved structure thereof (a structure wherein one silicon atom is removed from the cage structure or a structure wherein a part of silicon-oxygen bonds is cleaved) and is a condensation product obtained by reacting a trisilanol compound represented by the general formula (A) with an alkoxysilane represented by the general formula (B) and powdering and drying the resulting product by means of a thin-film distillation machine.

(RSiO_{3/2})ₙ(RSiO₂H)₃ (A)

R¹ₘSi(OR²)₄₋ₘ (B)

First, the trisilanol compound represented by the following general formula (A) for use in the invention will be explained.

(RSiO_{3/2})ₙ(RSiO₂H)₃ (A)

In the general formula (A), R is selected from a hydrogen atom, a substituted or unsubstituted hydrocarbon group having 1 to 20 carbon atoms, and a silicon atom-containing group having 1 to 10 silicon atoms, and a plurality of R's may be the same or different; and n is an integer of 2 to 10.

The trisilanol compound represented by the general formula (A) for use in the invention is a trisilanol compound having three trisilanol groups in the molecule thereof. Examples thereof include a type represented by the chemical formula [RSiO_{3/2}]₂[RSiO₂H]₃ (the following general formula (1)), a type represented by the chemical formula [RSiO_{3/2}]₄[RSiO₂H]₃ (the following general formula (2)), a type represented by the chemical formula [RSiO_{3/2}]₆[RSiO₂H]₃ (e.g., the following general formula (3)), a type represented by the chemical formula [RSiO_{3/2}]₈[RSiO₂H]₃ (e.g., the following general formula (4)), and a type represented by the chemical formula [RSiO_{3/2}]₁₀ [RSiO₂H]₃ (e.g., the following general formula (5)).

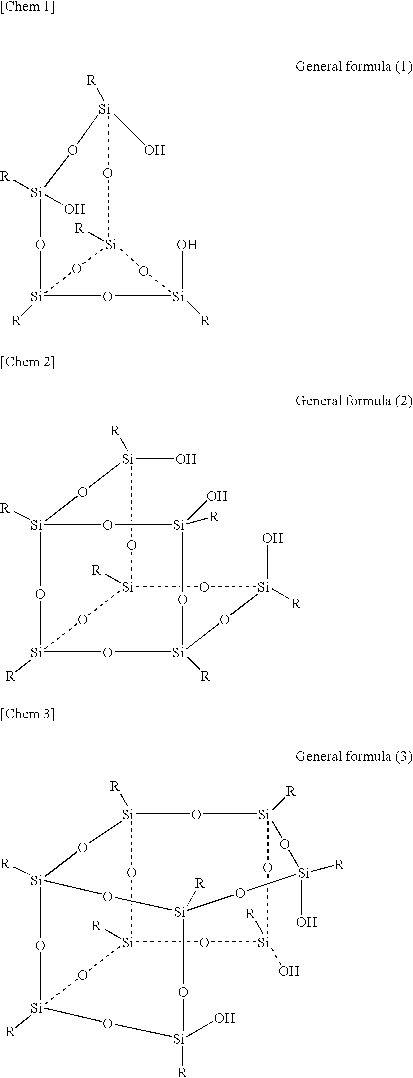

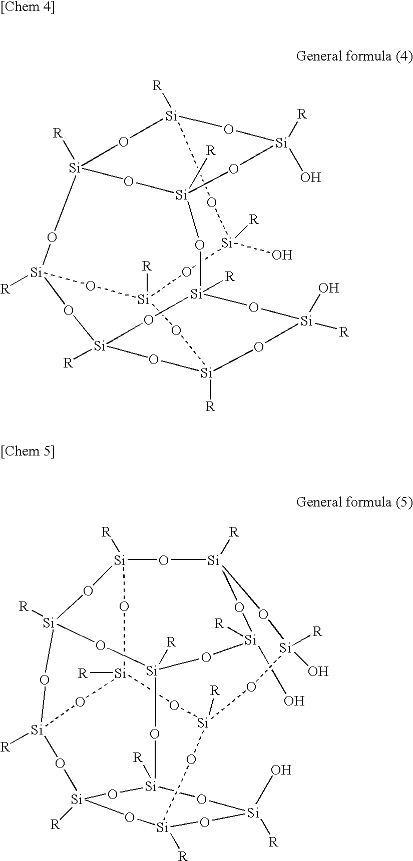

The value n in the trisilanol compound represented by the general formula (A) [RSiO_{3/2}]ₙ[RSiO₂H]₃ of the invention is an integer of 2 to 10, preferably 4, 6 or 8, more preferably 4 or 6 or a mixture of 4 and 6 or a mixture of 4, 6 and 8, particularly preferably 4.

As a synthetic example of the trisilanol compound for use in the invention, the methods described in J. Am. Chem. Soc. 1965, 87, 4313 reported by Brown et al may be mentioned. More specifically, for example, the trisilanol compound represented by the general formula (2) can be synthesized by treating cyclohexyltrichlorosilane with water/acetone. In addition, the method described in WO01/010871 pamphlet reported by Lichtenhan or the like may be mentioned. More specifically, the compound can be obtained by reacting isobutylalkoxysilane with lithium hydroxide and water in a mixed solution of acetone/methanol and neutralizing the resulting product with an acid such as hydrochloric acid.

The kinds of R in the compounds represented by the general formula (A) for use in the invention include a hydrogen atom, a substituted or unsubstituted hydrocarbon group having 1 to 10 carbon atoms, and a silicon atom-containing group having 1 to 3 silicon atoms.

Among the hydrocarbon groups having 1 to 10 carbon atoms, an aliphatic hydrocarbon group having 1 to 6 carbon atoms and an aromatic hydrocarbon group having 6 to 10 carbon atoms are preferred. An acyclic aliphatic hydrocarbon group having 1 to 5 carbon atoms and a cyclic aliphatic hydrocarbon group having 5 to 8 carbon atoms are more preferred.

Specific examples thereof include acyclic or cyclic aliphatic hydrocarbon groups such as methyl ethyl, n-propyl, i-propyl, butyl (n-butyl, i-butyl, t-butyl, sec-butyl), pentyl (n-pentyl, i-pentyl, neopentyl, cyclopentyl, etc.), and hexyl (cyclohexyl, etc.) groups; acyclic or cyclic alkenyl groups such as vinyl, propenyl, butenyl, pentenyl, hexenyl, cyclohexenyl, cyclohexenylethyl, norbornenylethyl, heptenyl, and octenyl groups; aralkyl groups such as benzyl, phenethyl, 2-methylbenzyl, 3-methylbenzyl, and 4-methylbenzyl groups; aralkenyl groups such as a PhCH═CH— group; aryl groups such as a phenyl group, a tolyl group, and a xylyl group; substituted aryl groups such as a 4-aminophenyl group, a 4-hydroxyphenyl group, a 4-metoxyphenyl group, and a 4-vinylphenyl group.

Furthermore, R for use in the invention may be a group wherein hydrogen atom(s) or a part of main chain skeleton of these various hydrocarbon groups may be partially replaced with substituent(s) selected from polar groups (polar bonds) such as an ether bond, an ester group (bond), a hydroxyl group, a thiol group, a thioether group, a carbonyl group, a carboxyl group, a carboxylic acid anhydride bond, a thiol group, a thioether bond, a sulfone group, an aldehyde group, an epoxy group, an amino group, a substituted amino group, an amide group (bond), an imide group (bond), a urea group (bond), a urethane group (bond), an isocyanate group, and a cyano group; halogen atoms such as fluorine atom, chlorine atom, and bromine atom; and the like.

As the silicon atom-containing group having 1 to 3 silicon atoms adopted as R, those having a wide variety of structures are adopted, and a group having the following general formula (6) or (7) may be mentioned, for example. The case where the number of the silicone atoms is too many is not preferable because the cage silsesquioxane compound becomes a viscous liquid and is not present as a solid in the range of 15° C. to 30° C.

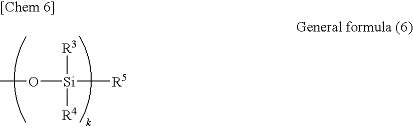

k in the general formula (6) is usually an integer in the range of 1 to 3. Moreover, the substituents R³ and R⁴ in the general formula (6) is a hydrogen atom, a hydroxyl group, an alkoxy group, a chlorine atom, or an organic group having 1 to 10 carbon atoms, preferably 1 to 10 carbon atoms other than an alkoxy group.

Examples of the alkoxy group include a methoxy group, an ethoxy group and a butoxy group.

As examples of the organic group having 1 to 10 carbon atoms other than an alkoxy group, various substituted or unsubstituted hydrocarbon groups may be mentioned. Specific examples thereof include aliphatic hydrocarbon groups such as a methyl group, an ethyl group, a propyl group, a butyl group, a pentyl group, a cyclopentyl group, a hexyl group, a cyclohexyl group, and a 2-cyclohexyl-ethyl group; unsaturated hydrocarbon bond-containing groups such as a vinyl group, an ethynyl group, an allyl group, and 2-cyclohexenyl-ethyl group; aromatic hydrocarbon groups such as a phenyl group, a benzyl group, and a phenethyl group; fluorine atom-containing groups such as fluorine-containing alkyl groups including 3,3,3-trifluoro-n-propyl group and fluorine-containing ether groups including a CF₃CF₂CF₂OCH₂CH₂CH₂— group; hydrocarbon groups partially substituted with a polar group, such as an aminopropyl group, an aminoethylaminopropyl group, an aminoethylaminophenethyl group, an acryloxypropyl group, and a cyanopropyl group. In this connection, in the general formula (6), two or more hydrogen atoms are not connected to the same silicon atom at the same time. Specific examples of the silicon atom-containing group represented by the general formula (6) include a trimethylsiloxy group (Me₃Si—), a dimethylphenylsiloxy group (Me₂PhSiO—), a diphenylmethylsiloxy group, a phenethyldimethylsiloxy group, a dimethyl-n-hexylsiloxy group, a dimethylcyclohexylsiloxy group, a dimethyloctylsiloxy group, (CH₃)₃SiO[Si(CH₃)₂O]₁-(1=1 or 2), a 2-phenyl-2,4,4,4-tetramethyldisiloxy group (OSiPhMeOSiMe₃), 4,4-diphenyl-2,2,4-trimethyldisiloxy (OSiMe₂OSiMePh₂), 2,4-diphenyl-2,4,4-trimethyldisiloxy (OSiPhMeOSiPhMe₂), a vinyldimethylsiloxy group, a 3-glycidylpropyldimethylsiloxy group, a 3-aminopropyldimethylsiloxy group (H₂NCH₂CH₂CH₂Me₂SiO—), Me₂NCH₂CH₂CH₂Me₂SiO—, H₂NCH₂CH₂CH₂Me(HO)SiO—, a 3-(2-aminoethylamino)propyldimethylsiloxy group (H₂NCH₂CH₂NHCH₂CH₂CH₂Me₂SiO—), MeHNCH₂CH₂NHCH₂CH₂CH₂Me₂SiO—, HOCH₂CH₂HNCH₂CH₂NHCH₂CH₂CH₂Me₂SiO—, CH₃COHNCH₂CH₂NHCH₂CH₂CH₂Me₂SiO—, and H₂NCH₂CH₂NHCH₂CH₂CH₂Me(HO)SiO—.

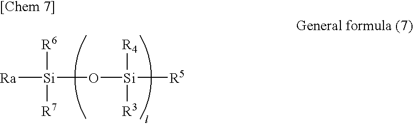

In the general formula (7), Ra is a divalent hydrocarbon group having 1 to 4 carbon atoms and the number of the carbon atoms is preferably 2 or 3. Specific examples of Ra include alkylene groups such as —CH₂CH₂— and —CH₂CH₂CH₂—.

The definitions of R³, R⁴ and R⁵ in the general formula (7) are the same as those of R³, R⁴ and R⁵ in the general formula (6), respectively. Moreover, the definitions of R⁶ and R⁷ are the same as those of R³ and R⁴. k is 0 or an integer in the range of 1 to 3 but is preferably 0, 1 or 2.

In the case where the cage silsesquioxane compound obtained by the invention is used in electronic material uses, it is necessary to reduce the contents of ionic impurities, particularly alkali metal compounds such as alkali metal ions or alkali metal salts in the cage silsesquioxane compound. In that cases, it is preferred to use one wherein the alkali metal compounds are removed in the stage of the trisilanol compound represented by the general formula (A) as a starting substance.

As a method for removing the alkali metal compounds from the trisilanol compound represented by the general formula (A) for use in the invention, there may be mentioned:

“a process for purifying the trisilanol compound represented by the general formula (A), which comprises a step (1) of bringing a composition containing at least both of the trisilanol compound represented by the general formula (A) and an alkali metal compound into contact with a hydrophobic organic solvent having a water solubility at 20° C. of 1.0% by weight or less to dissolve the trisilanol compound represented by the general formula (A) in the hydrophobic organic solvent and also to obtain an organic phase containing a fine-particle dispersoid and a step (2) of separating the fine-particle dispersoid from the organic phase containing the trisilanol compound represented by the general formula (A) and the fine-particle dispersoid obtained in the previous step”,
“a process for purifying the trisilanol compound represented by the general formula (A), wherein the above step (2) of separating the fine-particle dispersoid is a filtration treatment step”, and
“a process for purifying the trisilanol compound represented by the general formula (A) which contains an alkali metal compound and is represented by the general formula (1) or (2), which comprises a step (1′) of bringing a composition containing at least both of the trisilanol compound represented by the general formula (A) and an alkali metal compound into contact with a hydrophobic organic solvent having a water solubility at 20° C. of 1.0% by weight or less to dissolve the trisilanol compound represented by the general formula (A) in the hydrophobic organic solvent and a step (2′) of subjecting the organic phase obtained in the previous step to a filtration treatment”.

The fine-particle dispersoid in the invention contains an alkali metal compound.

The alkali metal compound is a generic term of any compound having an alkali metal atom. The alkali metal atom is a metal atom selected from lithium, sodium, potassium, rubidium, and cesium. Examples of the alkali metal compound include alkali metal salts (organic acid salts and inorganic acid salts) and basic alkali metal compounds (alkali metal hydroxides, alkali metal carbonates, alkali metal hydrogen carbonates, alkali metal alkoxides, etc.). In the trisilanol compound, one kind of the alkali metal may be contained or a plurality of the compounds may be contained.

Examples of the organic acid salts forming the alkali metal salts include a wide variety of organic acid salts such as organic carboxylate salts, organic sulfonate salts, and organic phosphate salts. Examples of the organic carboxylate salts include saturated carboxylate salts such as formate salts, acetate salts, and propionate salts, unsaturated carboxylate salts such as crotonate salts and acrylate salts, aromatic carboxylate salts such as benzoate salts, oxalate salts, and halogen atom-containing carboxylate salts such as trichloroacetate salts and trifluoroacetate salts.

As the inorganic acid salts forming the alkali metal salts for use in the invention, a wide variety of inorganic acid salts may be mentioned. Examples of the inorganic acid salts include carbonate salts, hydrogen carbonate salts, sulfate salts, hydrogen sulfate salts, sulfite salts, thiosulfate salts, phosphate salts, phosphite salts, hypophosphite salts, nitrate salts, borate salts, cyanate salts, thiocyanate salts, silicate salts, iodate salts and hydrohalogenate salts (e.g., hydrofluoride salts, hydrochloride salts, hydrobromide salts, hydroiodide salts).

The alkali metal compounds in the invention may be basic alkali metal compounds used in the production of the trisilanol compound represented by the general formula (A), those modified during synthetic reactions or thereafter, or those modified into alkali metal salts by the acid treatment in the production step of the trisilanol compound represented by the general formula (A).

As the hydrophobic organic solvent for use in the purification of the invention, an organic solvent having a water solubility at 20° C. of 1.0% by weight or less, preferably 0.5% by weight or less, more preferably 0.3% by weight or less, most preferably 0.1% by weight or less is used. The smaller water solubility toward the hydrophobic organic solvent is more preferred since the purification operation of removing the alkali metal compound is facilitated.

As the hydrophobic organic solvent for use in the invention, there is used an organic solvent which dissolves the trisilanol compound represented by the general formula (A) in an amount of 1% by weight or more, preferably 5% by weight or more, further preferably 10% by weight or more, most preferably 20% by weight or more at 20° C.

Specific examples of the hydrophobic organic solvent for use in the invention include aliphatic hydrocarbon-based solvents such as hexane, 2-methylpentane, 2,2-dimethylbutane, heptane, n-octane, isooctane, nonane, 2,2,5-trimethylhexane, and decane, aromatic hydrocarbon-based solvents such as benzene, toluene, xylene, ethybenzene, diethylbenzene, biphenyl, and styrene, halogenated hydrocarbon-based solvents such as methyl chloride, chloroform, carbon tetrachloride, ethyl chloride, 1,1-dichloroethane, 1,2-dichloroethane, 1,1,1-trichloroethane, 1,1,2-trichloroethane, 1,1,1,2-tetrachloroethane, 1,1,2,2-tetrachloroethane, pentachloroethane, 1,1-dichloroethylene, allyl chloride, and chlorobenzene, hydrophobic ethereal solvents such as dibutyl ether and dihexyl ether.

Among these various hydrophobic organic solvents, aliphatic hydrocarbon-based solvents and aromatic hydrocarbon-based solvents are more preferred in view of operability and purification performance. These hydrophobic organic solvents may be mixtures of two or more thereof.

The following will explain the purification step of the trisilanol compound represented by the general formula (A).

The following will explain the steps (1), (1′), (2) and (2′) in the above purification process.

b-1) Purification Steps (1) and (1′) of Trisilanol Compound Represented by General Formula (A)

The “composition containing at least both of the trisilanol compound represented by the general formula (A) and the alkali metal compound” for use in the steps (1) and (1′) of the invention may be any composition containing the trisilanol compound represented by the general formula (A) and the alkali metal compound and, in addition thereto, may contain various compounds, substances, solvents, and the like.

For example, the composition may contain various organic compounds, inorganic compounds, organic and inorganic composite compounds and salts, other than the alkali metal compound, may contain silicon compounds, such as silsesquioxane polymers and silicon-atom-containing oligomers, other than the trisilanol compound represented by the general formula (A), may contain various polymers and oligomers containing no silicon atom, and further may contain water and the other solvents. Therefore, the “composition containing at least both of the trisilanol compound represented by the general formula (A) and the alkali metal compound” for use in the steps (1) and (1′) of the invention may be a solid, a liquid, or a dispersed liquid.

One of preferred forms of the “composition containing at least both of the trisilanol compound represented by the general formula (A) and the alkali metal compound” for use in the steps (1) and (1′) of the invention is a composition wherein the content of the trisilanol compound represented by the general formula (A) is 80% by weight or more. The content of the trisilanol compound represented by the general formula (A) in the composition for use in the steps (1) and (1′) in this case is preferably 80% by weight or more, more preferably 90% by weight or more, further preferably 95% by weight or more, most preferably 99% by weight or more from the viewpoint of operability and efficiency of the steps. When the content of the trisilanol compound represented by the general formula (A) is too low, operation efficiency decreases.

Another preferred embodiment of the steps (1) and (1′) of the invention is “a process for purifying the trisilanol compound represented by the general formula (A), wherein the steps (1) and (1′) are a step of bringing an aqueous dispersion composition containing at least both of the trisilanol compound represented by the general formula (A) and the alkali metal compound into contact with a hydrophobic organic solvent to extract the trisilanol compound represented by the general formula (A) in the hydrophobic organic solvent and subsequently separating the phases to dissolve the trisilanol compound represented by the general formula (A) in the hydrophobic organic solvent and also to obtain an organic phase containing a fine-particle dispersoid”.

The above aqueous dispersion composition is a composition wherein the trisilanol compound represented by the general formula (A) is dispersed in water medium or a mixed medium containing at least water, and the alkali metal compound is dissolved and/or dispersed therein. Specific examples of the aqueous dispersion composition include “a composition wherein the trisilanol compound represented by the general formula (A) is dispersed in a water-containing medium and the alkali metal compound is dissolved and/or dispersed therein” formed in the step of producing the trisilanol compound represented by the general formula (A) but is not limited thereto.

By bringing the aqueous dispersion composition into contact with a hydrophobic organic solvent, the trisilanol compound represented by the general formula (A) is extracted into the hydrophobic organic solvent. When an aqueous phase and a hydrophobic organic solvent phase are separated after the operation to separate the hydrophobic organic solvent phase, the trisilanol compound represented by the general formula (A) is dissolved in the hydrophobic organic solvent and an organic phase containing a minute amount of the fine-particle dispersoid is obtained.

With regard to the content of water in the above aqueous dispersion composition, in the case of bringing the aqueous dispersion composition into contact with the hydrophobic organic solvent, it is sufficient that a sufficient amount of water is present for forming the two-phase system of an aqueous phase and an organic phase. However, in order to obtain practical operability, the lower limit of the content of water in the aqueous dispersion composition is preferably 1% by weight, more preferably 10% by weight, further preferably 20% by weight, most preferably 30% by weight. On the other hand, the upper limit of the water content is preferably 99% by weight, more preferably 95% by weight, further preferably 90% by weight, most preferably 85% by weight. When the water content is too low, the two-phase system of the aqueous phase and the organic phase is hardly formed, while when the water content is too high, the production efficiency of the trisilanol compound represented by the general formula (A) becomes worse. In this connection, even in the case where the two-phase system of the aqueous phase and the organic phase owing to the low water content, the purification process of the invention can be performed by separating the homogeneous solution in which the trisilanol compound represented by the general formula (A) is dissolved and the fine-particle dispersoid or the other insoluble component.

b-2) Purification Steps (2) and (2′) of Trisilanol Compound Represented by General Formula (A)

As a method of separating the fine-particle dispersoid and the trisilanol compound represented by the general formula (A) in the purification step (2) of the invention, various separation methods can be adopted. Specific examples of the separation methods include a filtration method, a centrifugation method, an adsorption method (e.g., a treatment with an adsorbent against polar substances), and a column separation method, but are not limited thereto and a plurality of the methods may be combined. Among these separation methods, a filtration treatment method is preferred in view of convenience of operations and efficiency of separation.

As the filtration treatment method for use in the purification steps (2) and (2′) of the invention, filtration through a filter is more preferred. The filtration treatment method and a treatment method other than the method may be performed in combination, as the case of the combination of the filtration method and the adsorption method.

As the filter material for use in the filtration, it is possible to use various materials such as natural polymers, synthetic polymers, ceramics, and metals.

Examples of the form include various porous membrane structures (flat membranes, pleated membranes, hollow membranes, etc.), various porous structures such as sintered structures, fabric and non-woven fabric structures, and fine-particle substance-packed structures. Furthermore, the method may be filtration through a filter using a filtration aid.

The average pore size of the porous filter is preferably 0.005 μm or more and 100 μm or less but, in view of convenience of operations, it is more preferably 0.01 μm or more and 10.0 μm or less, further preferably 0.01 μm or more and 5.0 μm or less, most preferably 0.01 μm or more and 3.0 μm or less.

The shape of the filter is preferably a membrane filter in view of operational convenience. The forms of the membrane filter may be various forms such as flat membranes, pleated membranes, and hollow fiber membranes. Among these membrane filters, a membrane filter is more preferred in view of operability and purification efficiency.

As the constitutive material of the hydrophobic membrane filter, there may be used a hydrophobic material having a contact angle against water at 25° C. to 35° C. of preferably 40° or more, more preferably 60° or more, further preferably 70° or more, most preferably 85° or more.

Specific examples of hydrophobic membrane filter include membrane filters using polypropylene (PP), polyethylene (PE), polyvinylidene fluoride (PVDF), polytetrafluoroethylene (PTFE), polysulfone, and the like as materials. Among them, in view of wide range of usable solvents and purification efficiency, a hydrophilic membrane filter formed of PTFE is particularly preferably used.

These hydrophilic membrane filters are used in various forms and examples thereof include various forms such as flat membranes, pleated membranes, and hollow fiber membranes.

The average pore size of the porous filter is preferably 0.005 μm or more and 100 μm or less, more preferably 0.01 μm or more and 10.0 μm or less, further preferably 0.01 μm or more and 5.0 μm or less, most preferably 0.01 μm or more and 3.0 μm or less.

In the invention, the removal of the alkali metal compound from the trisilanol compound represented by the general formula (A) can be easily confirmed by means of, for example, ion chromatography with an anion or a cation, ICP (inductively coupled plasma emission spectrometry), IR, or the like, but ICP is preferred owing to a good measurement limit.

When the solvent is removed from the solution containing the trisilanol compound represented by the general formula (A) obtained in the step (2) or (2′) by various methods, the trisilanol compound represented by the general formula (A) is obtained but one of preferred embodiments of the invention is “a process for purifying the trisilanol compound represented by the general formula (A), wherein a step of precipitating the trisilanol compound represented by the general formula (A) by adding a poor solvent for the trisilanol compound represented by the general formula (A) to the solution containing the trisilanol compound represented by the general formula (A) obtained in the step (2) or (2′) is incorporated”.

The following will explain utilization examples of the above process. For example, in the process for producing the trisilanol compound represented by the general formula (A) using a basic alkali metal compound, an oligomeric silsesquioxane compound is formed other than the objective trisilanol compound represented by the general formula (A) in some cases. Even in such cases, when the treatment of adding a poor solvent is applied, since only the trisilanol compound represented by the general formula (A) is selectively precipitated and the oligomeric silsesquioxane compound remains in the solution, the trisilanol compound represented by the general formula (A) and the oligomeric silsesquioxane compound can be easily separated by the operation.

The poor solvent for use in the operation is sufficiently a solvent miscible with the hydrophobic organic solvent for use in the above step and also a solvent having a low solubility of the trisilanol compound represented by the general formula (A). Specifically, as the poor solvent, a solvent which dissolves the trisilanol compound represented by the general formula (A) with a solubility of preferably 10% by weight or less, more preferably 5% by weight or less, further preferably 1% by weight or less may be used.

Specific examples of the poor solvent include nitrile-based solvents such as acetonitrile and propionitrile but are not limited thereto.

The following will explain the alkoxysilane represented by the general formula (B).

R¹ₘSi(OR²)₄₋ₘ General formula (B)

In the general formula (B), R¹ is selected from the group of the same group in the general formula (A) and a plurality of R¹'s may be the same or different. Moreover, OR² is an alkoxyl group having 1 to 6 carbon atoms. Specific examples of the alkoxyl group include a methoxy group, an ethoxy group, an n-propyloxy group, an i-propyloxy group, an n-butyloxy group, a t-butyloxy group, a pentyloxy group, a hexyloxy group, a cyclohexyloxy group. Among these alkoxyl groups, a methoxy group, an ethoxy group, an n-propyloxy group, an i-propyloxy group, and an n-butyloxy group are preferred and a methoxy group and an ethoxy group are more preferred. An alkoxyl group having 7 or more carbon atoms is not preferred since the reactivity thereof with the trisilanol compound, which is a partially cleaved structure of the cage silsesquioxane compound, becomes low.

Among the alkoxysilanes represented by the general formula (B), in the case where the alkoxysilane contains an amino group as a substituent in R¹, when the trisilanol compound represented by the general formula (A) and the alkoxysilane compound represented by the general formula (B) are brought into contact with each other, the objective product is obtained in high yields. The reaction of the trisilanol compound represented by the general formula (A) with the alkoxysilane having an amino group or a substituted amino group represented by the general formula (B) requires only the two components represented by the general formulae (A) and (B) as essential components and the other components are not particularly necessary. However, the reaction system may be a system wherein any of various Lewis acid, e.g., an aliphatic amine compound such as triethylamine, a heterocyclic nitrogen atom-containing compound such as pyridine, or an aromatic amine compound such as dimethylpyridine is added.

Specific examples of the amino group and the substituted amino group include H₂N(CH₂)₃—, H₂NCH₂—, H₂N(CH₂)₂—, H₂N(CH₂)₄—, H₂N(CH₂)₂HN(CH₂)₃—, H₂N(CH₂)₂HNCH₂—, H₂N(CH₂)₂NHCH₂CH(CH₃)CH₂—, H₂N(CH₂)₆NH(CH₂)₃—, MeHN(CH₂)₃—, EtHN(CH₂)₃—, Me₂N(CH₂)₂—, Et₂N(CH₂)₃—, Me₂NCH₂—, Et₂NCH₂—, MeHNCH₂—, EtHNCH₂—, H₂C═CHCH₂NH(CH₂)₂—, H₂N(CH₂)₂S(CH₂)₂—, H₂N(C₆H₄)—, H₂N(CH₂)₃OC(Me₂)₃C═C—, Ph-NH(CH₂)₃—, HOCH₂CH₂N(Me)(CH₂)₃— and C₅H₄N—CH₂CH₂—.

Moreover, in the case where R¹ of the alkoxysilane represented by the general formula (B) does not contain an amino group, the objective product is obtained in high yields by carrying out the reaction of the trisilanol compound represented by the general formula (A) with the alkoxysilane compound represented by the general formula (B) in the presence of a Lewis acid.

As the Lewis acid in that case, an amine compound having 1 to 20 carbon atoms is preferred and examples thereof include various Lewis bases such as aliphatic amine compounds, heterocyclic nitrogen atom-containing compounds, and aromatic amine compounds. Specific examples of the aliphatic amine compounds include primary amine compounds such as EtH₂N, n-PrH₂N, i-PrH₂N, n-BuH₂N, s-BuH₂N, t-BuH₂N, and CyH₂N, secondary amine compounds such as Et₂HN, n-Pr₂HN, i-Pr₂HN, n-Bu₂HN, s-Bu₂HN, t-Bu₂HN, and Cy₂HN, and tertiary amine compounds such as Me₃N, Et₃N, n-Pr₃N, i-Pr₃N, i-Pr₂EtN, and Cy₂EtN. Specific examples of the heterocyclic nitrogen atom-containing compound include pyridine, pyrrole and imidazole. Specific examples of the aromatic amine compound include dimethylpyridine, aniline, dimethylaniline, and the like. Among them, tertiary amine compounds and heterocyclic nitrogen atom compounds are preferred and particularly, a tertiary amine compound having a boiling point of 150° C. or lower, more preferably 120° C. or lower under atmospheric pressure is preferred since the removal by distillation after the reaction is easy.

The amount of the amine compound to the trisilanol compound represented by the general formula (A) of the invention is not particularly limited but the lower limit thereof is 0.01 mol %, more preferably 0.1 mol %, particularly preferably 1 mol %. The upper limit thereof is 500 mol %, more preferably 300 mol %, particularly preferably 100 mol %, further preferably 50 mol %. When the amine compound is less than 0.01 mol %, the objective reaction proceeds more slowly, so that the case is not preferred. When the compound is more than 500 mol %, the yield decreases owing to the formation of an amorphous cage silsesquioxane and the like other than the objective reaction, so that the case is not preferred.

As the organic solvent for use in the reaction of the invention, a mixed solvent including at least one solvent selected from hydrocarbon-based solvents, ethereal solvents and polar solvents and an alcoholic solvent having 1 to 8 carbon atoms is preferred. With regard to the solvent selected from hydrocarbon-based solvents, ethereal solvents and polar solvents, one kind or two or more kinds of solvents may be used so far as they are used as a mixed solvent with the alcoholic solvent. The mixed solvent including at least one solvent selected from hydrocarbon-based solvents, ethereal solvents and polar solvents and an alcoholic solvent having 1 to 8 carbon atoms is preferred since reaction selectivity is particularly excellent and the cage silsesquioxane compound is hardly agglomerated at the time when the solution containing the cage silsesquioxane compound is introduced into the thin-film distillation machine to effect solvent evaporation and powdering.

Specific examples of the hydrocarbon-based solvents, ethereal solvents, and polar solvents include hydrocarbon-based solvents such as hexane, cyclohexane, toluene, and xylene, various ethereal solvents such as tetrahydrofuran, dioxane, dimethoxyethane, ethylene glycol dimethyl ether, and diethylene glycol dimethyl ether, and polar solvents such as ethyl acetate, propyl acetate, butyl acetate, acetone, methyl ethyl ketone, methyl isobutyl ketone, and dimethylformamide. Among these solvents, a solvent having a boiling point of 150° C. or lower, further 120° C. or lower under atmospheric pressure is preferred since the removal by distillation after the reaction is easy.

As the alcoholic solvent, an alcoholic solvent having 1 to 8 carbon atoms is preferred. An alcoholic solvent having 1 to 6 carbon atoms is more preferred and an alcoholic solvent having 1 to 4 carbon atoms is particularly preferred. As the alcoholic solvent for use in the reaction of the invention, an alcoholic solvent having 9 or more carbon atoms is not preferred since it has a high boiling point and thus the solvent is not easily removed by evaporation.

Specific examples of the alcoholic solvent having 1 to 8 carbon atoms include methanol, ethanol, n-propanol, i-propanol, n-butanol, s-butanol, t-butanol, pentanol, hexanol, heptanol, and octanol. These alcoholic solvents may be used singly or a plurality of the alcoholic solvents may be used as a mixture. These alcoholic solvents may be used singly but it is preferred to use them as a mixed solvent with at least one solvent selected from hydrocarbon-based solvents, ethereal solvents, and polar solvents.

The composition of the mixed solvent including at least one solvent selected from hydrocarbon-based solvents, ethereal solvents and polar solvents and the alcoholic solvent having 1 to 8 carbon atoms is not particularly limited but, in order to effectively exhibit the effect of the alcoholic solvent, the alcoholic solvent is preferably contained in the range of 1 wt % or more and 95 wt % or less. Furthermore, as the lower limit of the content of the alcoholic solvent, it is preferably used in an amount of 10 wt %, and more preferred is 20 wt % and particularly preferred is 30 wt %. The upper limit of the alcoholic solvent is preferably 90 wt %, more preferably 80 wt %, particularly preferably 70 wt %.

The temperature of the reaction between the trisilanol compound represented by the general formula (A) and the alkoxysilane represented by the general formula (B) is not particularly limited but the lower limit of the reaction temperature is preferably −70° C., more preferably −50° C., particularly preferably −30° C. The upper limit of the reaction temperature is preferably 120° C., more preferably 100° C., particularly preferably 80° C. When the temperature is lower than −70° C., the reaction time increases and hence the case is not preferred. When the temperature is higher than 120° C., the other silsesquioxane is formed and the yield of the objective cage silsesquioxane decreases, so that the case is not preferred. In addition, in the reaction between the trisilanol compound represented by the general formula (A) and the alkoxysilane represented by the general formula (B), the pressure is not particularly limited and the production can be performed between 0.1 atm and 200 atm.

The trisilanol compound represented by the general formula (A) and the alkoxysilane represented by the general formula (B) each may be a single compound or may be a mixture of two or more kinds thereof.

The cage silsesquioxane compound formed by the reaction of the production process of the invention can be represented by any structure of the general formulae (C) to (E).

(RSiO_{3/2})ₙ₊₃(R¹SiO_{3/2}) (C)

(RSiO_{3/2})ₙ₊ₕ(RSiO₂H)₃₋ₕ(R¹ₘSiO_{(4-m)/2})ᵢ (D)

(RSiO_{3/2})ₙ₊₃(R¹₂SiO)(R¹₂SiO_{3/2}H) (E)

wherein n is an integer of 2 to 10; in the general formula (D), m=2 or 3; and in the case where m=2, i=1 and h=2; and in the case where m=3, i=h=an integer of 1 to 3.

As a specific example of the process for synthesizing the cage silsesquioxane of the general formula (C), for example, a process of reacting a trisilanol compound represented by the general formula (2) (n=4 in the general formula (A)) with R¹Si(OR²)₃ (m=1 in the general formula (B)) to obtain a cage silsesquioxane compound represented by the general formula (8) (n=4 in the general formula (C), i.e., the general formula (C) is (RSiO_{3/2})₇(RSiO_{3/2})) may be mentioned.

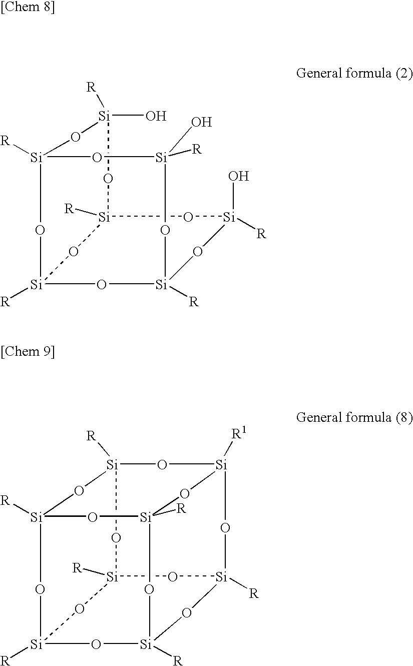

As a specific example of the process for synthesizing the cage silsesquioxane of the general formula (D), for example, when a trisilanol compound represented by the general formula (2) (n=4 in the general formula (A)) is reacted with R¹₂Si(OR²)₂ (m=2 in the general formula (B)), a cage silsesquioxane compound represented by the general formula (9) (n=4, m=2, i=1, and h=2 in the general formula (D), i.e., the general formula (D) is (RSiO_{3/2})₆(RSiO₂H)(R¹₂SiO)) can be obtained.

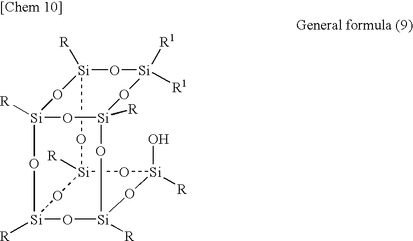

By reacting a trisilanol compound represented by the general formula (2) (n=4 in the general formula (A)) with 1 equivalent of R¹₃Si(OR²) (m=3 in the general formula (B)), a cage silsesquioxane compound represented by the general formula (10) (n=4, m=3, and h=i=1 in the general formula (D), i.e., the general formula (D) is (RSiO_{3/2})₅(RSiO₂H)₂(R¹₃SiO_{1/2})) can be obtained.

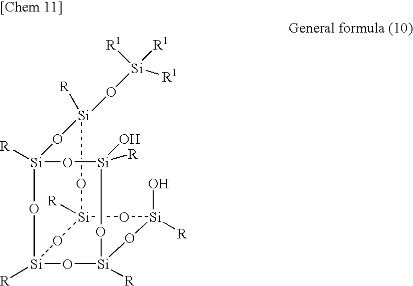

By reacting a trisilanol compound represented by the general formula (2) (n=4 in the general formula (A)) with 2 equivalents of R¹₃Si(OR²) (m=3 in the general formula (B)), a cage silsesquioxane compound represented by the general formula (11) (n=4, m=3, and h=i=2 in the general formula (D), i.e., the general formula (D) is (RSiO_{3/2})₆(RSiO₂H)(R¹₃SiO_{1/2})₂) can be obtained.

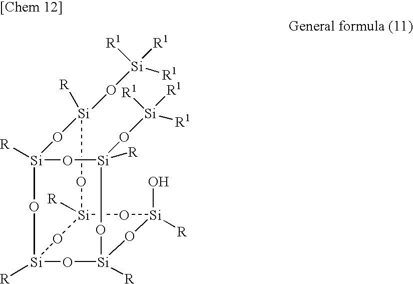

By reacting a trisilanol compound represented by the general formula (2) (n=4 in the general formula (A)) with 3 equivalents of R¹₃Si(OR²) (m=3 in the general formula (B)), a cage silsesquioxane compound represented by the general formula (12) (n=4, m=3, and h=i=3 in the general formula (D), i.e., the general formula (D) is (RSiO_{3/2})₇(R¹₃SiO_{1/2})₃) can be obtained.

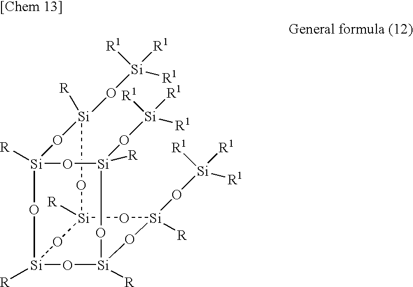

As a specific example of the process for synthesizing the cage silsesquioxane of the general formula (E), by reacting a trisilanol compound represented by the general formula (2) (n=4 in the general formula (A)) with 2 equivalents of R¹₂Si(OR²)₂ (m=2 in the general formula (B)), a cage silsesquioxane compound represented by the general formula (13) (the general formula (E) is (RSiO_{3/2})₇(R¹₂SiO)(R¹₂SiO_{3/2}H)) can be obtained.

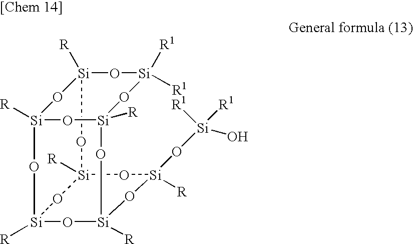

As the structure of the cage silsesquioxane compound formed in the invention, more preferred are cage silsesquioxane compounds represented by the general formulae (8), (9), and (12), and particularly preferred is a cage silsesquioxane compound represented by the general formula (8).

The following will explain the process for producing a powder of the cage silsesquioxane compound from the solution containing the formed cage silsesquioxane compound by means of a thin-film distillation machine.

The thin-film distillation machine for use in the invention is preferably a cylindrical distillation machine having rotating blades inside the machine. The distance between the rotating blades and the inner wall in the thin-film distillation machine is preferably 0.01 mm or more and 50 mm or less, more preferably 0.05 mm or more and 30 mm or less. When the distance between the blades and the wall is narrower than 0.01 mm, the blades come into contact with the inner wall at the rotation of the blades and the amount of chips derived from shaving of the materials constituting the blades and the inner wall increases, so that the case is not preferred. Moreover, when the distance between the blades and the wall is 50 mm or more, a thin film is hardly formed at the time when the solution containing the cage silsesquioxane compound is fed and the particle size of the resulting powder increases, so that the case is not preferred. The blade may be a fixed type or a movable type but the movable type blade is preferred since the particle size of the powder of the resulting cage silsesquioxane compound becomes small owing to the movement of the blade at the running of the thin-film distillation machine.

Moreover, the thin-film distillation machine for use in the invention is preferably the machine fitted with a jacket which can be heated with a heat transfer medium, steam, or the like or the machine having a structure in which the inner wall can be heated by a heater or the like.

As the inner wall temperature resulting from heating of the inner wall of the thin-film distillation machine by the jacket, the heater, or the like used in the invention, the temperature of the heat transfer medium of the jacket or the temperature of the heater can be used as a substitute. The range of the inner wall temperature of the thin-film distillation machine is preferably 10° C. or more lower than either lower temperature of the melting point or softening temperature of the cage silsesquioxane compound. More preferably, the range is 20° C. or more lower than either lower temperature of the melting point or softening temperature of the cage silsesquioxane compound. In order to easily remove the solvent, it is preferred to heat it to a temperature as high as possible. However, when the inner wall of the thin-film distillation machine is heated to a temperature higher than the temperature 10° C. or more lower than either lower temperature of the melting point or softening temperature of the cage silsesquioxane compound, the cage silsesquioxane compound tends to be agglomerated to form a wax and it is difficult to form a powder, so that the case is not preferred.

The either lower temperature of the melting point or softening temperature of the cage silsesquioxane compound usable in the invention is 50° C. or higher, more preferably 70° C. or higher. When the either lower temperature of the melting point or softening temperature of the cage silsesquioxane compound is lower than 50° C., the formed cage silsesquioxane compound tends to be agglomerated, so that the case is not preferred. The melting point or softening temperature of the cage silsesquioxane compound can be easily analyzed, for example, by the measurement of differential scanning calorimetry (DSC) or the like.

The range of the pressure in the thin-film distillation machine for use in the invention is not particularly limited but, in order to reduce the amount of the residual solvents in the powder after the powder production of the cage silsesquioxane compound, it is preferred to run the thin-film distillation machine in a pressure-reduced state of atmospheric pressure or lower.

The solvent of the solution containing the cage silsesquioxane compound to be introduced to the thin-film distillation machine may be a single solvent or a mixed solvent. In the invention, the operations from the reaction through the powdering are continuously performed and the solution before the powdering may contain the alcoholic solvent generated in the reaction in some cases.

Specific examples of the solvent of the solution containing the cage silsesquioxane compound to be introduced to the thin-film distillation machine include hydrocarbon-based solvents such as hexane, cyclohexane, toluene, and xylene, various ethereal solvents such as tetrahydrofuran, dioxane, dimethoxyethane, ethylene glycol dimethyl ether, and diethylene glycol dimethyl ether, and polar solvents such as ethyl acetate, propyl acetate, butyl acetate, acetone, methyl ethyl ketone, methyl isobutyl ketone, dimethylformamide, dimethylacetamide, dimethyl sulfoxide, and N-methylpyrrolidone and various alcoholic solvents having 1 to 8 carbon atoms such as methanol, ethanol, n-propanol, i-propanol, n-butanol, s-butanol, t-butanol, pentanol, hexanol, heptanol, and octanol.

The solvent composition in the solution containing the cage silsesquioxane compound to be introduced to the thin-film distillation machine is not always coincident with the solution composition immediately after the reaction. For example, there is a case where a condensation step is intervened and the solvent composition may vary depending on the boiling point of the solvent species.

When the solvent in the solution containing the cage silsesquioxane compound to be introduced to the thin-film distillation machine is a mixed solvent, the alcoholic solvent is preferably contained in the range of 1 wt % or more and 95 wt % or less based on 100 wt % of the mixed solvent. More preferred is 2 wt % or more and 70 wt % or less and further preferred is 3 wt % or more and 50 wt % or less. From the viewpoint of easy powdering at the time when the solvent is evaporated by means of the thin-film distillation machine, the lower limit is preferably 1 wt %. Moreover, from the viewpoint of the concentration of the solution containing the cage silsesquioxane compound or the viewpoint of suppressing the amount of the solvent to be evaporated, and furthermore form the viewpoint of little loss thereof resulting from the attachment to the inner wall and the like of the thin-film distillation machine and decrease in the amount of the residual solvents in the powder, the upper limit of the alcoholic solvent is preferably 95 wt %.

Furthermore, by selecting an appropriate range of the amount of the alcoholic solvent, a powder of the cage silsesquioxane compound having more uniform particle size can be obtained. The uniformity of the powder is extremely important for the following reason. For example, an extruder is sometimes used at melt blending of the powder of the cage silsesquioxane compound with a polymer in some cases. At that time, when the particle size of the powder is uniform, the feed ratio of the raw materials is also uniform and thus a polymer composition having a stable quality can be continuously obtained.

The range of the viscosity at the treatment of the solution containing the cage silsesquioxane compound in the thin-film distillation machine is preferably in the range of 0.1 cp or more and 1000 cp or less, more preferably 0.3 cp or more and 800 cp or less. Particularly preferred is a range of 0.3 cp or more and 500 cp or less. When the viscosity is higher than 1000 cp, a thin film is hardly formed at the time when the solution containing the cage silsesquioxane compound is fed, so that the case is not preferred. When the solution has a viscosity of less than 0.1 cp, since the concentration of the solution containing the cage silsesquioxane compound decreases, the amount of the solvent to be evaporate by the thin-film distillation method increases and hence a large energy is required for obtaining the powder, so that the case is not preferred.

Moreover, with regard to the solution containing the cage silsesquioxane compound, a solution containing the cage silsesquioxane compound obtained by reacting the above trisilanol compound represented by the general formula (A) with the alkoxysilane represented by the general formula (B) may be continuously introduced into the thin-film distillation machine as it is and then treated, the solution containing the cage silsesquioxane compound obtained by the reaction may be continuously treated after concentration, or after the addition of a solid inorganic substance or the like, the solvent evaporation and powdering may be continuously performed in the thin-film distillation machine.

The cage silsesquioxane compound obtained by the continuous treatment in the thin-film distillation machine may be further pulverized by means of a pulverizer or the like depending on intended usage. By treating it by the pulverizer or the like, a powder having a particle size depending on the intended usage can be obtained.

The range of the average particle size of the powder of the cage silsesquioxane compound produced by the process of the invention is preferably 1 μm or more and 10 mm or less. More preferred is 3 μm or more and 5 mm or less, and further more preferred is 5 μm or more and 3 mm or less. From the viewpoint of productivity for obtaining a powder without pulverization and from the viewpoint of stably obtaining a high-quality composition with a polymer as mentioned above, the lower limit of the average size is preferably 1 μm and the upper limit is preferably 10 mm. With regard to the average size of the powder, the particles are sieved, the weight of each fraction is measured, and the diameter of the particles corresponding to a central cumulative value (median diameter) is determined as an average particle size from a cumulative curve of particle size distribution.

With regard to the amount of the residual solvents contained in the powder of the cage silsesquioxane compound produced by the invention, in the case where the cage silsesquioxane compound and a resin are blended, from the viewpoint of the mechanical physical properties of the resulting composition, the upper limit of the amount of the residual solvents contained in the powder of the cage silsesquioxane compound is preferably 3 wt %, and more preferred is 1 wt % or less. The amount of the residual solvents can be easily analyzed by gas chromatography (GC), thermogravimetry (TG), or the like.

The cage silsesquioxane compound obtained in the invention can be easily analyzed by means of a nuclear magnetic resonance spectrometer (¹H-NMR, ²⁹Si-NMR) or by gas chromatography (GC), gel permeation chromatography (GPC), infrared absorption spectrum (IR), mass spectrometry (MS), or the like.

In the production process of the invention, an objective powder of the cage silsesquioxane compound can be produced almost quantitatively. Even in the case of using a catalyst, since the catalyst component and the like are simultaneously removed at the time when the solvent is evaporated to form a powder, handling becomes easy and thus the process is industrially an extremely useful production process. In this connection, in the case where a highly pure objective product is required, the resulting powder can be further purified by various purification methods such as washing with a poor solvent, recrystallization, and separation through a column and then used.

In the case where the powder of the cage silsesquioxane compound obtained in the invention is added to a thermoplastic resin, e.g., a polyolefin-based resin, a polycarbonate-based resin, a polyamide-based resin, a polyphenylene ether-based resin, a polyester-based resin such as polybutylene terephthalate or polyethylene terephthalate, a polyacetal-based resin, a polysulfone-based resin, or the like, the powder can be homogeneously added thereto by a method of premix blending before extrusion, a method of separate addition through a side feeder, or the like without pulverization, solvent blending, or the like. Among them, a large improved effect on fluidity and flame resistance is achieved by adding the powder to a polyphenylene ether-based resin.

In addition, since the powder of the cage silsesquioxane compound obtained by the process of the invention does not use any compound containing a halogen atom such as a chlorine atom as a direct synthetic raw material, the content of halogenated compounds is extremely low and hence the powder is suitable as a resin additive for electronic material fields.

### EXAMPLES

The following will describe the mode for carrying out the invention in detail with reference to Examples and Comparative Examples. The invention is not limited thereto.

Products of Hybrid Plastics Company (USA) were employed as the used trisilanol compounds whose production was not described.

The resulting cage silsesquioxane compounds were analyzed as follows.

1) Thin-film distillation machine: Hi-Evaolator® VHF 1001 Model manufactured by Sakura Seisakusho, Ltd. was used.
2) ¹H NMR: GSX 400 Model NMR manufactured by JOEL Ltd. was used and CDCl₃ was used as a solvent.
3) ²⁹Si NMR: GSX 400 Model NMR manufactured by JOEL Ltd. was used and CDCl₃ was used as a solvent.
4) GC: GC-1700 Model GC manufactured by Shimadzu Corporation was used, DB-1 column manufactured by J & W SCIENTIFIC Company was used, the compound was dissolved in chloroform and then measured, and the purity and amount of the residual solvents were determined from the area ratio of the resulting peak.
5) Electrospray Ionization-Mass Spectrometry (ESI-MS): LCQ manufactured by Thermoquest was used and the sample was dissolved in methanol in the concentration of 0.01 mg/mL and measured in the range of m/z=150 to 2000 by ESI-MS method.
6) DSC: DSC-60A manufactured by Shimadzu Corporation was used and the melting point or softening temperature was determined by temperature-elevating measurement from 30° C. at 5° C./minute.
7) Particle size: a micro-type electromagnetic vibrating sieve M-2 Model (manufactured by Tsutsui Scientific Instruments Co., Ltd.) was used, particles were sieved, the weight of each fraction was measured, and the diameter of the particles corresponding to a central cumulative value (median diameter) was determined as an average particle size from a cumulative curve of particle size distribution.

### Example 1

In a 10 L reactor fitted with a jacket, 2.0 kg of heptaisobutyl-heptasilsesquioxane-trisilanol (R=iBu, X═OH in the general formula (2)) was dissolved in a mixed solvent composed of 2.33 kg of toluene and 2.33 kg of methanol and the liquid temperature was cooled to −5° C. by cooling the jacket. Then, 0.572 kg of 2-aminoethyl-(3-aminopropyl)trimethoxysilane was added to the solution at a liquid temperature ranging from −5 to −10° C. at 2.1 g/minute by means of a tube pump. After the completion of the addition, the mixture was stirred in the range of −5 to −10° C. for 2 hours and subsequently the reaction liquid was taken out of the reactor. Then, the solvents, methanol and toluene, were evaporated at 400 kPa under heating on a water bath at 50° C. to obtain a solution having a cage silsesquioxane compound concentration of 60 wt %. The viscosity of the resulting cage silsesquioxane compound solution was 11 cp at 23° C. From GC of the solution, it was found that the cage silsesquioxane compound solution contains 32 wt % of toluene and 8 wt % of methanol. The above cage silsesquioxane compound solution was introduced at 4 kg/h into a thin-film distillation machine whose jacket temperature was 80° C. and whose inside was reduced to 20 kPa, and the solvent was evaporated and dried to thereby obtain 2.21 kg of a white powder. The average particle size thereof was 0.85 mm. The content of lumps having a size of 5 mm or more was 0 wt %. Moreover, adherent was hardly observed on the inner wall of the thin-film distillation machine. When the resulting white powder was analyzed by ¹H and ²⁹SiNMR, peaks characteristic to the compound A (¹H, 0.61 ppm, 0.96 ppm, 1.59 ppm, 1.86 ppm, 2.45 ppm, 2.63 ppm, 2.81 ppm; ²⁹Si: −67.7 ppm, −67.5 ppm, −67.0 ppm) were obtained. From GC analysis of the white powder, the composition of the white powder was found to be 98.1% of heptaisobutyl-(2-aminoethyl(3-aminopropyl)octasilsesquioxane (compound A), 0.5% of octaisobutyloctasilsesquioxane, and 1.2% of heptaisobutyl-(3-aminopropyl)octasilsesquioxane. In addition, it was found that the content of toluene in the white powder was 0.3 wt % and the content of methanol was 0.1 wt % or less. From ESI-MS of the resulting white powder, m/z=918 [M+H]⁺ was obtained. From DSC measurement of the resulting white powder, the softening start temperature was found to be 141° C.

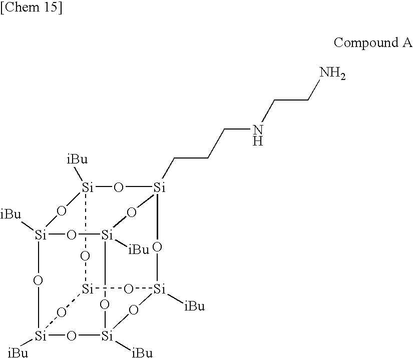

### Comparative Example 1

A reaction was carried out in the same manner as in Example 1 and solvent evaporation and drying were performed by means of an evaporator.

In a three-necked flask fitted with a reflux condenser and a dropping funnel, 200 g of heptaisobutyl-heptasilsesquioxane-trisilanol (R=iBu, X═OH in the general formula (2)) was dissolved in a mixed solvent composed of 233 g of toluene and 233 g of methanol. Then, 57.2 g of aminoethylaminopropyltrimethoxysilane was added dropwise thereto in the range of −5° C. to −8° C. After the completion of the dropwise addition, stirring was conducted for 2 hours and then concentration and drying were performed at 70° C. by means of an evaporator to obtain a waxy cake containing a cage silsesquioxane compound represented by the compound A as a main component. Moreover, from GC, it was found that the toluene content was 2.3 wt % and the content of methanol was 0.4 wt % in the cake.

### Example 2

In a 10 L reactor fitted with a jacket, 2.0 kg of heptaisobutyl-heptasilsesquioxane-trisilanol (R=iBu, X═OH in the general formula (2)) was dissolved in a mixed solvent composed of 2.33 kg of toluene and 2.33 kg of methanol and the liquid temperature was cooled to −5° C. by cooling the jacket. Then, 0.559 kg of 3-aminopropyltriethoxysilane was added to the solution at a liquid temperature ranging from −5 to −10° C. at 2.1 g/minute by means of a tube pump. After the completion of the addition, the mixture was stirred in the range of −5 to −10° C. for 2 hours and subsequently the reaction liquid was taken out of the reactor. Then, the solvents, methanol and toluene, were evaporated at 400 kPa under heating on a water bath at 50° C. to obtain a solution having a cage silsesquioxane compound concentration of 60 wt %. The viscosity of the resulting cage silsesquioxane compound solution was 12 cp at 23° C. From GC of the solution, it was found that the cage silsesquioxane compound solution contains 32 wt % of toluene and 8 wt % of methanol. The above cage silsesquioxane compound solution was introduced at 4 kg/h into a thin-film distillation machine whose jacket temperature was 80° C. and whose inside was reduced to 20 kPa and the solvent was evaporated and dried to thereby obtain 2132 g of a white powder. The average particle size thereof was 0.64 mm. The content of lumps having a size of 5 mm or more was 0 wt %. When the resulting white powder was analyzed by and ²⁹SiNMR, peaks characteristic to heptaisobutyl-(aminopropyl)octasilsesquioxane (compound B) (¹H, 0.60 ppm, 0.95 ppm, 1.59 ppm, 1.85 ppm, 2.63 ppm, 2.81 ppm, 3.24 ppm; ²⁹Si: −67.7 ppm, −67.5 ppm, −67.1 ppm) were obtained. From GC analysis, it was found that the content of toluene in the resulting white powder was 0.2 wt % and the content of methanol was 0.1 wt % or less. In addition, ESI-MS of the resulting white powder was measured and m/z=875 [M+H]⁺ was obtained. From DSC measurement of the resulting white powder, the melting point was found to be 160° C.

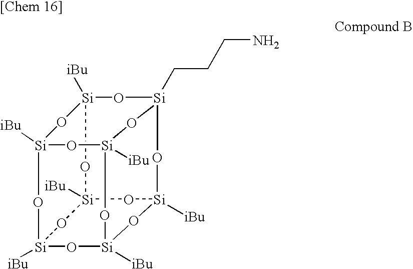

### Example 3

In a 10 L reactor fitted with a jacket, 2.0 kg of heptaisobutyl-heptasilsesquioxane-trisilanol (R=iBu, X═OH in the general formula (2)) was dissolved in a mixed solvent composed of 2.33 kg of toluene and 2.33 kg of methanol, and 50 g of triethylamine was added. Then, 0.410 kg of allyltriethoxysilane was added thereto at 25° C. at 2.1 g/minute by means of a tube pump. After the completion of the addition, the mixture was stirred for 2 hours, subsequently the liquid temperature was elevated to 50° C., and after 2 hours of stirring, the reaction liquid was taken out of the reactor. Then, the solvents, methanol and toluene, were evaporated at 400 kPa under heating on a water bath at 50° C. to obtain a solution having a cage silsesquioxane compound concentration of 60 wt %. The viscosity of the resulting cage silsesquioxane compound solution was 10 cp at 23° C. From GC of the solution, it was found that the cage silsesquioxane compound solution contains 32 wt % of toluene and 8 wt % of methanol. The above cage silsesquioxane compound solution was introduced at 4 kg/h into a thin-film distillation machine whose jacket temperature was 80° C. and whose inside was reduced to 20 kPa and the solvent was evaporated and dried to thereby obtain 2167 g of a white powder. The average particle size thereof was 0.72 mm. The content of lumps having a size of 5 mm or more was 0 wt %. When the resulting cage silsesquioxane was analyzed by ¹H and ²⁹SiNMR, peaks characteristic to heptaisobutyl-(allyl)octasilsesquioxane (compound C) (¹H, 0.59 ppm, 0.96 ppm, 1.60 ppm, 1.85 ppm, 4.89 ppm, 4.95 ppm, 5.74 ppm; ²⁹Si: −67.2 ppm, −67.6 ppm, −71.5 ppm) were obtained. From GC analysis, it was found that the content of toluene in the resulting white powder was 0.3 wt % and the content of methanol was 0.1 wt % or less. In addition, ESI-MS (Positive) of the resulting white powder was measured and m/z=858 [M+H]⁺ was obtained. From DSC measurement of the resulting white powder, the melting point was found to be 245° C.

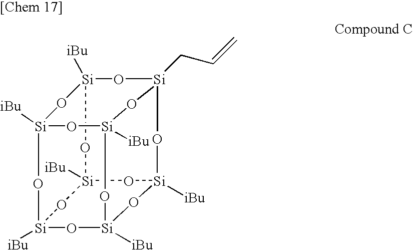

### Example 4

In a three-necked glass flask fitted with a reflux condenser and a dropping funnel, 2.0 kg of heptaisobutyl-heptasilsesquioxane-trisilanol (R=iBu, X═OH in the general formula (2)) was dissolved in a mixed solvent composed of 2333 g of toluene and 2333 g of methanol, and 50 g of triethylamine was added. Then, 0.375 kg of vinyltrimethoxysilane was added thereto at room temperature. After the completion of the addition, the mixture was heated to 60° C. and stirred for 6 hours. Then, the solvents, methanol and toluene, were evaporated at 400 kPa under heating on a water bath at 50° C. to obtain a solution having a cage silsesquioxane compound concentration of 60 wt %. The viscosity of the resulting solution was 9 cp. From GC of the solution, it was found that the cage silsesquioxane compound solution contains 32 wt % of toluene and 8 wt % of methanol. The solution was introduced at 4 kg/h into a thin-film distillation machine whose jacket temperature was 80° C. and whose degree of reduced pressure was set at 20 kPa, and 2005 g of a white powder was obtained. The average particle size thereof was 0.47 mm. The content of lumps having a size of 5 mm or more was 0 wt %. When the resulting white powder was analyzed by ¹H and ²⁹SiNMR, peaks characteristic to heptaisobutyl-(vinyl)octasilsesquioxane (compound D) (¹H, 0.62 ppm, 0.96 ppm, 1.87 ppm, 6.02 ppm; ²⁹Si: −67.2 ppm, −67.6 ppm, −81.3 ppm) were obtained. From GC analysis, in the resulting white powder, it was found that the content of toluene was 0.1 wt % and the content of methanol was 0.1 wt % or less. In addition, ESI-MS (Positive) of the resulting white powder was measured and m/z=844 [M+H]⁺ was obtained. From DSC measurement of the resulting white powder, the melting point was found to be 232° C.

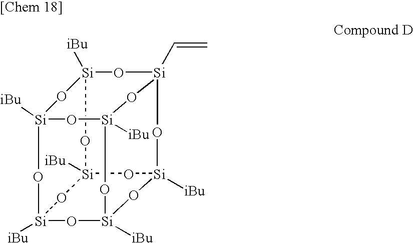

### Example 5

In a three-necked glass flask fitted with a reflux condenser and a dropping funnel, 2.0 kg of heptaisobutyl-heptasilsesquioxane-trisilanol (R=iBu, X═OH in the general formula (2)) was dissolved in a mixed solvent composed of 2.33 kg of toluene and 2.33 kg of methanol, and 50 g of triethylamine was added. Then, 0.628 kg of methacryloxypropyltrimethoxysilane was added thereto at room temperature. The mixture was stirred at room temperature (about 25° C.) for 6 hours. Then, the solvents, methanol and toluene, were evaporated at 400 kPa under heating on a water bath at 50° C. to obtain a solution having a cage silsesquioxane compound concentration of 60 wt %. The viscosity of the resulting solution was 20 cp at 23° C. From GC of the solution, it was found that the cage silsesquioxane compound solution contains 32 wt % of toluene and 8 wt % of methanol. The solution was introduced at 4 kg/h into a thin-film distillation machine whose jacket temperature was 80° C. and whose degree of reduced pressure was set at 20 kPa and 2104 g of a white powder was obtained. The average particle size thereof was 0.62 mm. The content of lumps having a size of 5 mm or more was 0 wt %. When the resulting white powder was analyzed by ¹H and ²⁹SiNMR, peaks characteristic to heptaisobutyl-(methacryloxypropyl)octasilsesquioxane (compound E) (¹H:ppm, 0.58 ppm, 0.65 ppm, 0.94 ppm, 1.76 ppm, 1.84 ppm, 1.93 ppm, 4.09 ppm, 5.52 ppm, 6.08 ppm; ²⁹Si: −68.0 ppm, −68.2 ppm, −68.3 ppm) were obtained. From GC analysis, in the resulting white powder, it was found that the content of toluene was 0.2 wt % and the content of methanol was 0.1 wt % or less. In addition, ESI-MS (Positive) of the resulting white powder was measured and m/z=944 [M+H]⁺ was obtained. From DSC measurement of the resulting white powder, the softening start temperature was found to be 112° C.

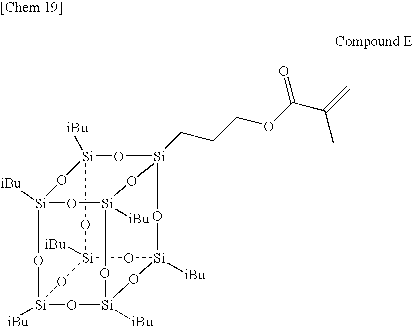

### Example 6

Operations were performed in a similar manner to Example 1 with the exception that ethanol was used instead of methanol. The average particle size of the resulting powder was 0.32 mm and the content of lumps having a size of 5 mm or more was 0 wt %. In addition, little attached matter was observed on the inner wall of the thin-film distillation machine.

### Example 7

Operations were performed in a similar manner to Example 1 with the exception that methanol was not used. The average particle size of the resulting powder was 0.97 mm and the content of lumps having a size of 5 mm or more was 6 wt %. In addition, the amount of the attached matter observed on the inner wall of the thin-film distillation machine was slightly larger than that in Example 1.

### Example 8

Operations were performed in a similar manner to Example 2 with the exception that methanol was not used. The average particle size of the resulting powder was 1.1 mm and the content of lumps having a size of 5 mm or more was 11 wt %.

### Example 9

### Synthesis and Purification of (iBuSiO_{1.5})₄(iBu(OH)SiO_{1.0})₃

Into a pressure-resistant reaction vessel having an inner volume of 500 ml was introduced 6.36 (152 mmol) of lithium hydroxide monohydrate, and then 4.64 ml (258 mmol) of pure water and 66 ml (908 mmol) of acetone were added sequentially, followed by stirring. Thereto was charged 55.98 (314 mmol) of isobutyltrimethoxysilane, and then the reaction vessel was closed.

Under stirring of the reaction solution, an oil bath was heated at 100° C. and the reaction was continued for another 3 hours. After the completion of the reaction, the reaction vessel was cooled on standing and the reaction solution was transferred to a 1000 ml eggplant-shaped flask. When 300 ml of a 1N aqueous acetic acid solution was added under stirring of the reaction solution, there was obtained a slurry liquid in which a fine-particle substance was dispersed.

After 300 ml of toluene was added to the slurry liquid and the mixture was stirred, it was allowed to stand and was separated into two phases. Then, the toluene phase obtained by the phase separation was filtrated through a PTFE membrane filter (manufactured by ADVANTEC Company) having a pore size of 0.10 μm. The filtrate was concentrated by means of an evaporator, the concentration was stopped when solid matter was begun to precipitate, and 300 ml of acetonitrile was added to precipitate the solid matter. The solid matter was separated by filtration and dried at 80° C. under a vacuum pressure of 75 cmHg for 2 hours to obtain 30.2 g of a white powder.

By ²⁹SiNMR spectrum analysis, it was confirmed that the white powdery substance was a polyhedral oligosilsesquioxane having a trisilanol structure (a partially cleaved structure of a cage silsesquioxane having a trisilanol structure) represented by (iBuSiO_{1.5})₄(iBu(OH)SiO_{1.0})₃. The yield of 30.2 g corresponds to a percent yield of 85% as a trisilanol compound. In addition, the purity of the trisilanol compound determined from ²⁹SiNMR spectrum was 99.0%. The content of acetic acid ion in the trisilanol compound was 10 ppm or less (lower than detection limit) based on anion chromatography and the content of lithium atom was 0.13 ppm based on ICP-MS analysis.

Operations were performed in a similar manner to the method described in Example 1 with the exception that the production of the trisilanol as a raw material. The average particle size of the resulting compound A was 0.85 mm and the content of lithium atom contained in the compound A was 0.10 ppm based on ICP-MS analysis.

As apparent from the above, objective powders of cage silsesquioxanes excellent in particle size uniformity can be produced effectively and continuously in high yields and in high purity.

While the invention has been described in detail and with reference to specific embodiments thereof, it will be apparent to one skilled in the art that various changes and modifications can be made therein without departing from the spirit and scope thereof.

The present application is based on Japanese Patent Application No. 2006-273781 filed on Oct. 5, 2006, and the contents are incorporated herein by reference.

### INDUSTRIAL APPLICABILITY

According to the process of the present invention, the objective cage silsesquioxane compound can be produced almost quantitatively. Even in the case of using a catalyst, since the catalyst component and the like are simultaneously removed at the time when the solvent is evaporated to form a powder, handling becomes easy and thus the process is industrially extremely useful. In addition, since the powder of the cage silsesquioxane compound obtained by the process of the invention does not use any compound containing a halogen atom such as a chlorine atom as a direct synthetic raw material, the content of halogenated compounds is extremely low and hence the powder is suitable as a resin additive for electronic material fields.

1. A process for producing a powder of a cage silsesquioxane compound, said process comprising:
reacting a trisilanol compound represented by the general formula (A) with an alkoxysilane represented by the general formula (B) in an organic solvent in the presence of a Lewis base to obtain a solution containing the cage silsesquioxane compound, and
subsequently performing a solvent evaporation and powdering of the solution by means of a thin-film distillation machine, simultaneously:
(RSiO_{3/2})ₙ(RSiO₂H)₃ (A)
R¹ₘSi(OR²)₄₋ₘ (B)
wherein, in the general formula (A), R is selected from a hydrogen atom, a substituted or unsubstituted hydrocarbon group having 1 to 10 carbon atoms, and a silicon atom-containing group having 1 to 3 silicon atoms, and a plurality of R's may be the same or different; and n is an integer of 2 to 10; in the general formula (B), R¹ is a group selected from the group the same as that for the above R, and a plurality of R¹'s may be the same or different; OR² is an alkoxyl group having 1 to 6 carbon atoms; and m is an integer of 1 to 3.

2. The process for producing the powder of the cage silsesquioxane compound according to claim 1, wherein R¹ in the alkoxysilane represented by the general formula (B) has an amino group as a substituent.

3. The process for producing the powder of the cage silsesquioxane compound according to claim 1, wherein the Lewis base is an alkoxysilane containing the amino group.

4. The process for producing the powder of the cage silsesquioxane compound according to claim 1, wherein the Lewis base is an amine compound having 1 to 20 carbon atoms.

5. The process for producing the powder of the cage silsesquioxane compound according to claim 1, wherein the cage silsesquioxane compound is represented by any structure of the following formulae (C) to (E):
(RSiO_{3/2})ₙ₊₃(R¹SiO_{3/2}) (C)
(RSiO_{3/2})ₙ₊ₕ(RSiO₂H)₃₊ₕ(R¹ₘSiO_{(4-m)/2})ᵢ (D)
(RSiO_{3/2})ₙ₊₃(R¹₂SiO)(R¹₂SiO_{3/2}H) (E)
wherein n, R and R¹ are the same as described in the above claim 1; m=2 or 3; and in the case where m=2, i=1 and h=2; and in the case where m=3, i=h=an integer of 1 to 3.

6. The process for producing the powder of the cage silsesquioxane compound according to claim 1, wherein the trisilanol compound represented by the general formula (A) is:
(RSiO_{3/2})₄(RSiO₂H)₃,
the alkoxysilane represented by the general formula (B) is:
R¹Si(OR²)₃,
and the cage silsesquioxane compound obtained by reacting the trisilanol compound with the alkoxysilane is:
(RSiO_{3/2})₇(R¹SiO_{3/2})
wherein R and R¹ are the same as described in the above claim 1.

7. The process for producing the powder of the cage silsesquioxane compound according to claim 1, wherein the solvent of the solution containing the cage silsesquioxane compound is a mixed solvent of at least one solvent selected from hydrocarbon-based solvents, ethereal solvents and polar solvents and an alcoholic solvent having 1 to 8 carbon atoms, and the mixed solvent contains 1 wt % to 95 wt % of the alcoholic solvent based on 100 wt % of the mixed solvent.

8. The process for producing the powder of the cage silsesquioxane compound according to claim 1, wherein a viscosity of the solution containing the cage silsesquioxane compound at the time when it is treated in the thin-film distillation machine is 0.1 cp to 1000 cp.

9. The process for producing the powder of the cage silsesquioxane compound according to claim 1, wherein a temperature of an inner wall of the thin-film distillation machine is a temperature which is 10° C. or more lower than either lower temperature of a melting point or a softening start temperature of the cage silsesquioxane compound.

10. The process for producing the powder of the cage silsesquioxane compound according to claim 1, wherein either lower temperature of the melting point or the softening start temperature of the cage silsesquioxane compound is 50° C. or higher.

11. The process for producing the powder of the cage silsesquioxane compound according to claim 1, wherein a residual amount of the solvent contained in the powder of the cage silsesquioxane compound is 3 wt % or less.

12. The process for producing the powder of the cage silsesquioxane compound according to claim 1, wherein the trisilanol compound represented by the general formula (A) is subjected to a treatment of removing alkali metal compounds shown by the following steps:
(a) a composition containing the trisilanol compound is brought into contact with a hydrophobic organic solvent having a water solubility at 20° C. of 1.0% by weight or less to obtain an organic phase wherein the trisilanol compound represented by the general formula (A) is dissolved in the hydrophobic organic solvent, and
(b) a fine-particle dispersoid is removed from the hydrophobic organic solvent phase.

13. The process for producing the powder of the cage silsesquioxane compound according to claim 12, wherein the step of removing the fine-particle dispersoid is a step of a filtration treatment through a hydrophobic filter having an average pore size of 0.005 μm to 100 μm.
